(19) United States
(12) Patent Application Publication
(10) Pub. No.: US 2003/0009279 A1
(43) Pub. Date: Jan. 9, 2003

(54) Demand information integration apparatus, demand information integrating method, server device, client device, and storage medium

(75) Inventor: Akio Kawamoto, Yokohama (JP)

Correspondence Address: STAAS & HALSEY LLP, 700 11TH STREET, NW, SUITE 500, WASHINGTON, DC, 20001, US

(73) Assignee: FUJITSU LIMITED

(21) Appl. No.: 10/186,391

(22) Filed: Jul. 1, 2002

(30) Foreign Application Priority Data
Jul. 6, 2001 (JP) 2001-206356
Mar. 15, 2002 (JP) 2002-072720

(51) Int. Cl. G01C 21/26

(52) U.S. Cl. 701/200

(57) ABSTRACT

Information transmitted from the information terminal of each store is stored in the current store information database of a center. When a client accesses from a mobile terminal to the center through a network, the store information about the nearest store is generated according to the transmitted location information, transmitted to the client together with a service code, and stored in the location information database. When an information terminal transmits the service code indicated by the client who visits the store, the visiting date and time are registered in the visit information database. Various analyses can be carried out according to the information stored in each database. Additionally, the visiting rate can be enhanced by notifying clients of the map information, etc. about the location of the store.

### BACKGROUND OF THE INVENTION

1. Field of the Invention

The present invention relates to a system for integrating client demand information associated with store information.

2. Description of the Related Art

With recent fierce competition in the service industries including restaurants, etc., efficiently collecting and analyzing client information are more and more important in preparing management strategies.

In the present methods for collecting and analyzing information used in each service industry, information is collected from clients who actually visit stores, and a demand analysis is carried out according to the information. However, some clients cannot actually visit a store for any reasons. For example, although the clients came to the store, the store may have been full of clients. Therefore, in the above mentioned methods, the information cannot be obtained from these clients.

Additionally, a client of a store can come to the store, but the parking lot may be full, the client may be kept waiting outside or not allowed in due to the crowd.

Furthermore, the service industries widely use advertising through various media, for example, a Web page, etc. to improve a visiting rate. However, there has often been the problem that a Web page or a large amount of access to the page cannot enhance the visiting rate.

### SUMMARY OF THE INVENTION

The present invention aims at providing a system of collecting and analyzing the information about the clients not only actually visiting stores, but also stopping actually visiting the stores.

The present invention also aims at providing a system of confirming the condition of a store, for example, the occupied space rate, etc. of the store before actually visiting the store.

It also aims at providing a system of supplying to a service user a service for contribution to improvement of the visiting rate.

The demand information integrating method according to the present invention includes a step of generating the identification information for identification of the information about a service user, a step of receiving the identification information from the service user, and a step of storing the identification information as associated with the store information at the time when the identification information is received.

The information about the service user includes, for example, location information, time information, or both location information and time information.

The store information includes, for example, unoccupied seat information, parking lot information, or both unoccupied seat information and parking lot information.

With the above mentioned configuration, a service user actually visiting a store presents the identification information, thereby designating the service user accessing the server device according to the identification information.

When a service user accesses the system, the service user transmits the location information about the location of the service user, and the location information can be stored as associated with the identification information, thereby efficiently associating various pieces of information about the area accessed by the service user, access records, visit records, date and time information, etc. with one another, and successfully obtaining the information for practical management strategies.

The demand information integrating method according to the second embodiment of the present invention includes a step of receiving service user information about a service user; a step of generating identification information for identification of the service user information; and a step of returning notification information including the identification information to the service user. The notification information includes at least one of store information about, for example, the situation of a store and parking lot information about the unoccupied seat information about a parking lot. Otherwise, the notification information includes map information about the location of a store.

Thus, the information for contribution to the improvement of the visiting rate can be provided as notification information for a service user.

The present invention can also solve the above mentioned problem by realizing the demand information integration apparatus including the units for realizing the above mentioned steps, a program used to direct a computer to perform similar control, and a computer-readable storage medium storing the program. Additionally, the present invention can also be realized as an embodiment of a computer data signal representing control software provided with a transmission medium.

### BRIEF DESCRIPTIONS OF THE DRAWINGS

FIG. 1 shows the configuration of the system according to an embodiment of the present invention;

FIG. 2A shows an example of a configuration of the data stored in a location information database, FIG. 2B shows an example of a configuration of the data stored in a store occupancy information database, FIGS. 2C and 2D show examples of configurations of the data stored in current store information databases, and FIG. 2E shows an example of a configuration of the data stored in a territory information database;

FIG. 3 shows the flow of the process performed by the system according to an embodiment of the present invention;

FIG. 4 shows the first example of an application of the information stored in the client demand information integration apparatus;

FIG. 5 shows an explanatory image of the second example of an application of the information stored in the client demand information integration apparatus;

FIG. 6 shows the second example of an application of the information stored in the client demand information integration apparatus;

FIGS. 7A and 7B show an example of the material for a trend analysis generated according to the information extracted from the client demand information integration apparatus in the second example of application;

FIG. 8 shows the third example of an application of the information stored in the client demand information integration apparatus;

FIG. 9 is a flowchart of the processes performed by a location information collection program and a mobile terminal in response to access from a client;

FIG. 10 is a flowchart of an example of the process of generating a service code;

FIG. 11 is a flowchart of the process performed by the client demand information integration apparatus when a service code of a visiting client is transmitted from an information terminal of a store;

FIG. 12 is a flowchart of the update process of store information when a client visits a store managed by the central system;

FIG. 13 is a flowchart of the update process of store information when a client exits a store managed by the central system;

FIG. 14A, 14B and 14C show an example of map information used in the second embodiment of the present invention;

FIG. 15 is a flowchart of the entry process of an important area database;

FIG. 16 is a flowchart of the details of the visit record confirming process;

FIG. 17 is a flowchart of the process performed by the location information integration program in response to the access from a client according to the second embodiment of the present invention;

FIG. 18 is a flowchart of the details of the map information editing process;

FIG. 19 shows the environment of the information process system of the central system; and

FIG. 20 shows an example of a storage medium.

### DESCRIPTION OF THE PREFERRED EMBODIMENTS

The embodiments of the present invention are described below by referring to the attached drawings.

According to an embodiment of the present invention, a client accesses a service provider through a network using a mobile terminal, etc., and receives store information about the situation of a store such as the occupancy state, etc. On the other hand, in response to the access of the client, the service provider receives the location information about the access location from the terminal of the client, and uses the location information as the client demand analysis information by collecting it together with the information as to whether or not the client has actually visited.

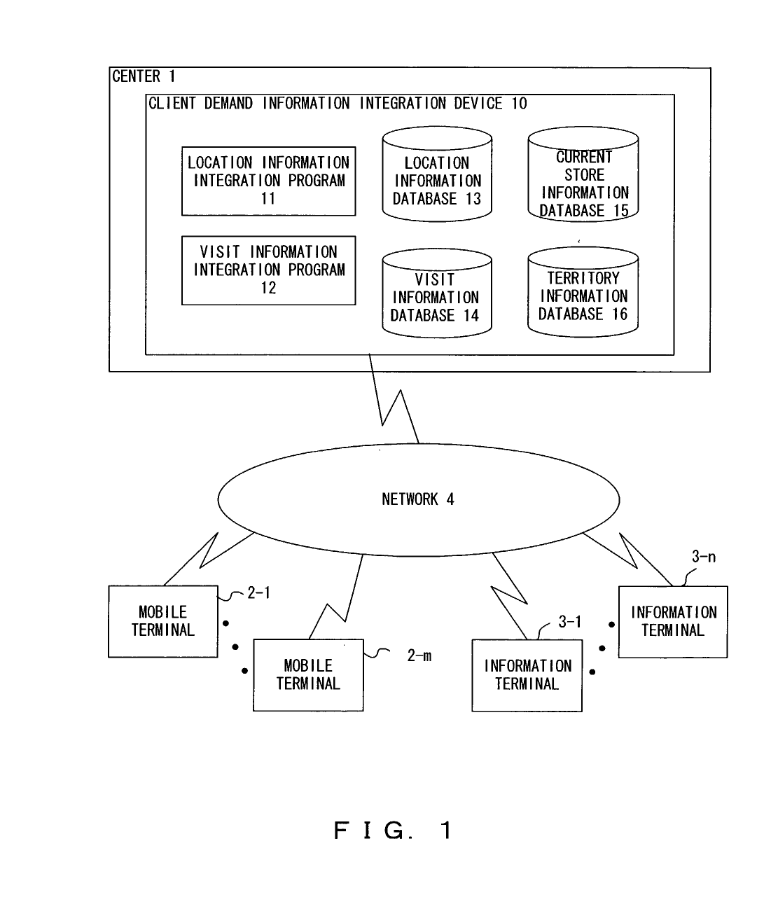

FIG. 1 shows the configuration of the system according to an embodiment of the present invention.

In the present system shown in FIG. 1, a center 1 for collecting and analyzing the information about clients and stores is connected to mobile terminals 2-1 through 2-m of the client and information terminals 3-1 through 3-n provided in the store through a network 4 such as Internet, etc.

The center 1 is provided with a client demand information integration device 10 and collects and manages the client information about each store managed by the center 1. The client demand information integration device 10 collects and manages each piece of information about a store managed by the center 1, and functions as a network server. The center 1 comprises: a location information integration program 11 for collecting the location information about a client accessing the center 1 through the network 4; a visit information integration program 12 for collecting the visit record of a client accessing the center 1; a location information database 13; a visit information database 14; a current store information database 15; and a territory information database 16.

The mobile terminal 2 of the client can be a mobile terminal such as a mobile telephone, a PHS, a car phone, a PDA, a car navigation having the ability to connect to a network, etc., and can be connected to the network 4 by radio communications. The mobile terminal 2 obtains the location information about the current location by the GPS, the electric wave measurement, etc., and arbitrarily transmits it. The location designation ability can be configured to be assigned to the mobile terminal 2, or to another device connected to the mobile terminal 2 so that the location information can be received from the device. According to the present embodiment, the terminal used by a client is a mobile terminal, but a device other than the mobile terminal can be connected to the center 1 through a public networks, and any terminal such as a desk top personal computer, etc. which can transmit location information to the center 1 is applicable as the mobile terminal 2.

The information terminal 3 is an information terminal device operated with a POS (Point Of Sales system) used by a staff of a store and a parking ticket dispenser, and transmits in real time the store information about the condition of a store to the center 1 through the network 4.

The network 4 is a public network such as Internet, etc. and connects the center 1, the mobile terminals 2-1 through 2-m, and the information terminals 3-1 through 3-n managed by the center 1. In FIG. 1, the network connecting the center 1 with the mobile terminal 2 is the network connecting the center 1 with the information terminal 3, but different networks can be used. For example, the network between and the center 1 and the mobile terminal 2 can be configured by connecting the public network, and the network between the center 1 and the information terminal 3 can be configured by connecting an exclusive line.

The center 1 updates and stores the store information about the situation of each store on the current store information database 15 according to the information transmitted from the information terminal 3 of each store managed by the center 1 by using the client demand information integration device 10. When the client accesses the center 1 from the mobile terminal 2 through the network 4, the center 1 reads the store information about the situation of the nearest store from the current store information database 15, and transmits it to the client. At this time, the client demand information integration device 10 receives the location information designating the location of the client accessing from the mobile terminal 2 of the client, and stores the location information in the location information database 13.

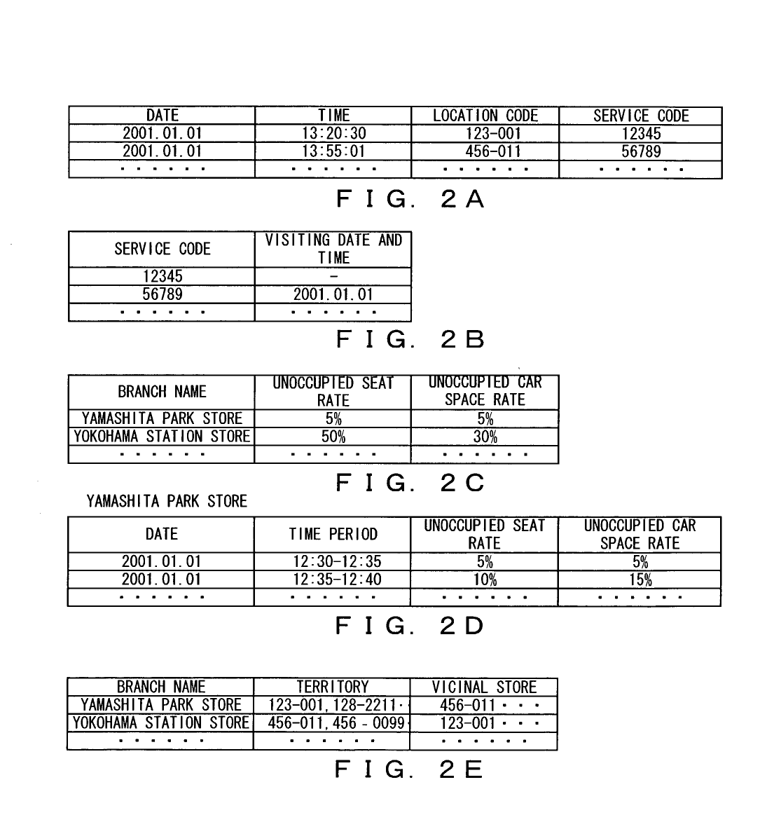

FIG. 2 shows an example of a configuration of the data stored in the location information database 13, the visit information database 14, the current store information database 15, and the territory information database 16.

The location information database 13 stores the time of a client accessing the center 1 and the location information, and, in the example shown in FIG. 2A, the date, the time, the location code (according to the present embodiment, the location code indicates the location using coordinates, etc. as location information) indicating the access location information, and the service code as associated with one another. The service code is described later.

The visit information database 14 stores the visit information about a client accessing the center 1. In the example shown in FIG. 2B, the service code and the date and time of the visit of a client are associated with each other and stored. If the client accesses the center 1 and a service code is generated, and a record storing the service code is generated in the visit information database 14. When the client visits the store and presents the service code, the visiting date and time are stored in the corresponding record. Therefore, the visiting date and time are stored in the record of the service code of the client actually visiting the store only. As a result, based on the number of records storing the visiting date and time and the number of records not storing them, the number (visit records) of clients actually visiting the store out of the number of the persons accessing the center 1 can be obtained. The configuration of the visit information database 14 can be configured such that a visit flag can be recorded instead of recording the visiting time.

The current store information database 15 stores the store information such as the unoccupied seat rate, etc. about the current situation of each store, and stores the current store information about the current situation of each store and the time-series store information storing the status of each time period of each store. FIG. 2C shows an example of a configuration of the current store information. In the example shown in FIG. 2C, each branch name and the current unoccupied seat rate and the unoccupied car space rate of the parking lot of the branch are stored as associated with one another. FIG. 2D shows an example of a configuration of the data of one store of the time-series store information. In the example shown in FIG. 2D, this data is for Yamashita Park Store, and the time and date, the time period, the unoccupied seat rate and the unoccupied car space rate of the parking lot at the time are stored as associated with one another. Although not specifically shown in FIG. 2C, the current store information stores the number of seats, remaining seats, all car spaces, and remaining car spaces of each store to obtain the unoccupied seat rate and the unoccupied car space rate, thereby updating the data according to the information from the information terminal 3 of each store.

The territory information database 16 stores a territory table showing each store and the territory assigned to each store. In the example shown in FIG. 2E, each branch name, the location code of the territory of the branch, and the location code of the vicinal area of the branch are stored as associated with one another. In response to the access from a client, the client demand information integration device 10 searches the territory information database 16 and retrieves the nearest store.

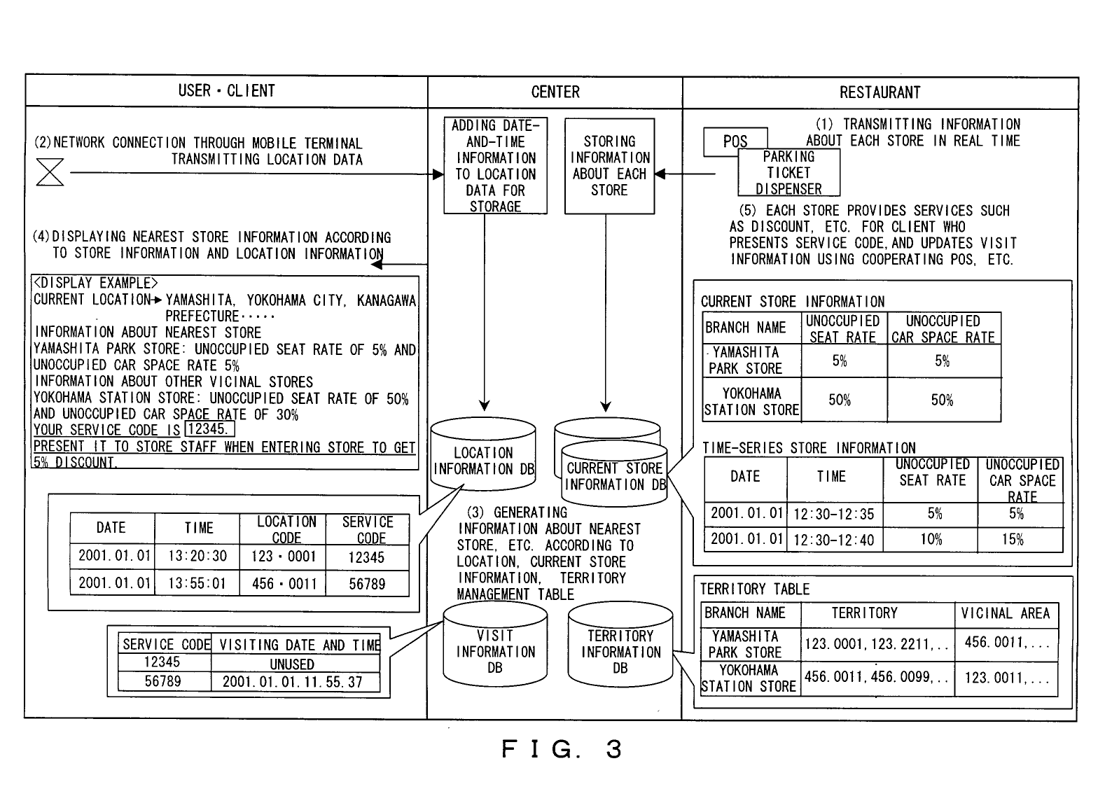

FIG. 3 shows a flow of the process performed by the system shown in FIG. 1.

FIG. 3 shows an example and a case in which the system according to the present embodiment is applied in a restaurant chain. In the explanation below, the system according to the present embodiment is applied to a restaurant chain. The embodiment is not limited to a restaurant chain, but can be applied to any store which can provide a service for a number of general clients, have the upper limit of the number of clients, and grasp the situation of a store such as movie theaters, bowling alleys, theme parks, etc. (1) through (5) in the explanation below correspond to the numbers shown in FIG. 3.

In each restaurant, when a client enters/exits a store, or when a car enters/exits the parking lot, that is, when the situation of the store changes, the information terminal 3 operated with a POS or a parking lot ticket dispenser notifies the center 1 through the network 4 of the number of incoming/outgoing clients and the number of incoming/outgoing cars ((1)).

In the center 1, the client demand information integration device 10 updates the data in the current store information database 15 in real time according to the above mentioned information.

In this situation, a user (client) going to use the restaurant connects the mobile terminal 2 to the center 1 through the network 4 such as Internet, etc. ((2)). At this time, the location information about the current location of the client is transmitted as an information code from the mobile terminal 2 to the center 1. The center 1 searches the territory table stored in the territory information database 16 using the location code as a search key to retrieve the nearest branch (store in the territory) and the vicinal branch (store in the vicinity) based on the access location of the client. The store information about the current situation of the branch is retrieved from the current store information database 15 using the store name as a retrieval key. Based on the information retrieved from the current store information database 15, the information as notification of the situation of the store such as the unoccupied seat rate, the unoccupied car space rate, etc. of the nearest branch and the vicinal store is generated ((3)).

At this time, the client demand information integration device 10 generates a service code which is a unique identifier for the client accessing the center 1. According to the present embodiment, the service code is used for identification of the client accessing the center 1, and for identification as to whether or not the client has actually visited the store.

Then, the information as a notification of the situation of each store generated in (3) is transmitted together with the generated service code to the mobile terminal 2 of the client. Thus, the information such as the unoccupied seat rate, the unoccupied car space rate of the parking lot, etc., of the nearest store, and the service code are displayed on the mobile terminal 2 ((4)). In the displayed example shown in FIG. 3, the unoccupied seat rates and the unoccupied car space rates of the parking lots of the Yamashita Park Store as the nearest store and the Yokohama Station Store as the vicinal store and the service code 12345 are displayed on the mobile terminal 2.

The client demand information integration device 10 enters the service code together with the information about access date and time and the access location in the location information database 13. It also generates and enters the record with the service code and the visiting date and time in a blank state for the visit information database 14.

The client checks the information such as the unoccupied seat rate, the unoccupied car space rate, etc. of the nearest store and the vicinal store displayed on the mobile terminal 2, selects and visits the appropriate store, or stops visiting the stores. When the client visits a store, he or she tells the service code displayed on the mobile terminal 2 to the staff, and the staff notifies the center 1 of the service code, records the visiting time in the visit information database 14, and gives the client a service such as a discount, etc. ((5)).

Thus, by the access of the mobile terminal 2 of the client and the information terminal 3, the information in the client demand information integration device 10 is updated and accumulated. And this information can be used for an analysis as to which area has a large (small) amount of access, which state of a store or a parking lot makes a client stop visiting, etc. as described later.

Furthermore, the client can check the state of a store such as an occupancy state, etc. before actually visiting the store, and can determined whether or not he or she is to actually visit the store. In this system, the client can receive a service such as a discount, etc.

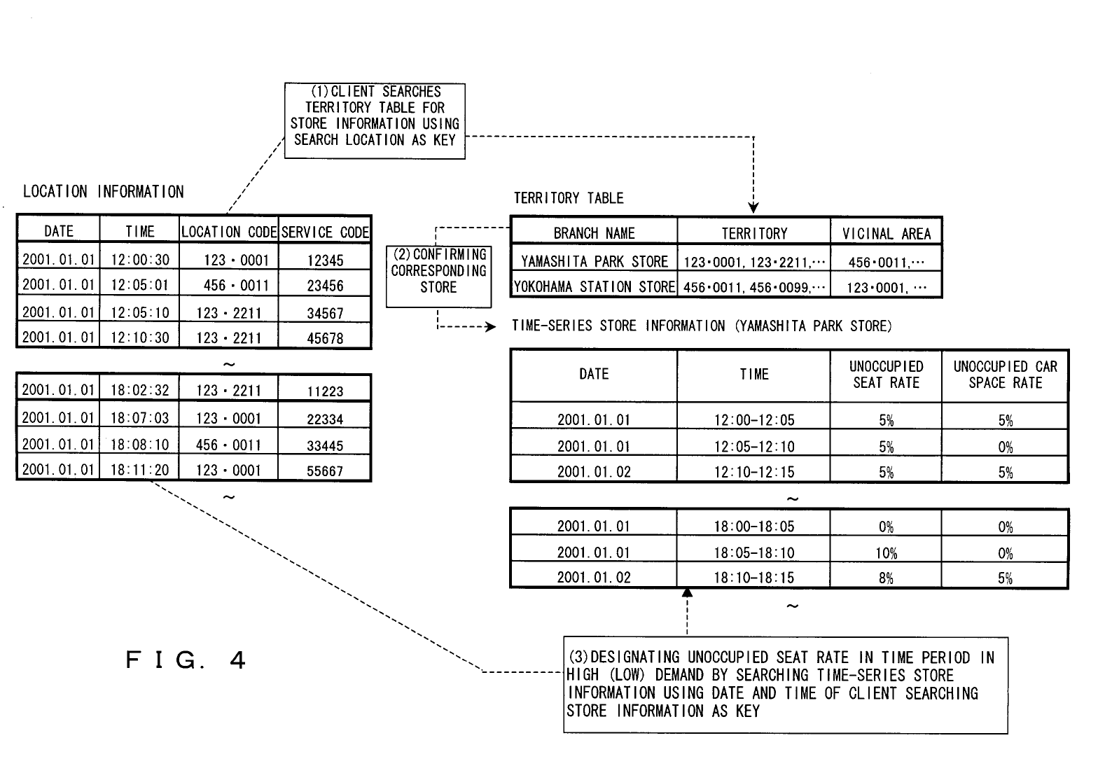

FIG. 4 shows the first example of an application of the information stored in the client demand information integration apparatus 10. (1) through (3) in the explanation below correspond to the numbers shown in FIG. 4.

In the example shown in FIG. 4, data in the location information database 13, the current store information database 15, and the territory information database 16 are used, and a demand analysis is carried out according to the location information about the access location to the center 1.

In FIG. 4, the location information database 13 is searched using as a search key the time period on which an analysis is to be carried out, the location information (location code) about the location of the client who accessed the center 1 in the time period is obtained, and the territory information database 16 is searched using as a search key the location code ((1)), thereby confirming the corresponding store ((2)). Then, the current store information database 15 is searched based on the access time stored in the location information database 13 so that the unoccupied seat rate in a time period in large (small) demand can be designated.

In the case shown in FIG. 4, the Yamashita Park Store and the Yokohama Station Store are selected as target stores according to the location information about the client who accessed the center 1 and visited the target store at lunch time (12:00-13:00) and supper time (18:00-20:00) as the time period to be analyzed, and the unoccupied seat rate and the unoccupied car space rate at the time period of lunch time and supper time of the Yamashita Park Store and the Yokohama Station Store are retrieved from the time-series store information in the current store information database 15.

As a result of the search above, it is determined that a large number of clients request (demand) to visit the Yamashita Park Store at lunch time and supper time. On the other hand, a small number of clients request (demand) to visit the Yokohama Station Store. Relating to the Yamashita Park Store, the analysis result indicates a high occupancy rate in a time period of high demand. These results can be an appropriate material for use in preparing a reduction or enlargement plan of each store, a new store plan, etc.

Thus, the analysis of the occupancy rate in a high (low) demand time period using the information recorded in the client demand information integration device 10 can be effectively used in planning the reduction, enlargement, etc. of a store.

Described below is the second example of an application of the information stored in the client demand information integration device 10.

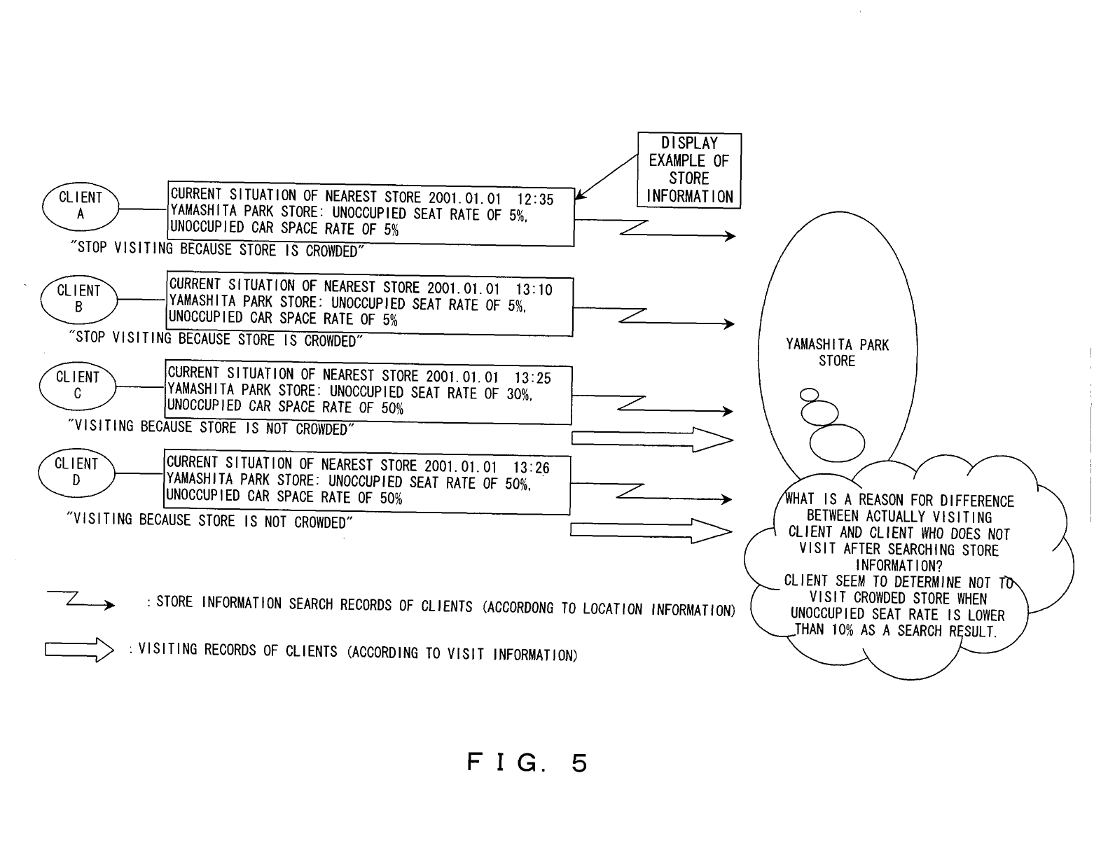

FIG. 5 is an explanatory view of the second example of an application.

In the system according to the present embodiment, a client can obtain store information such as the unoccupied seat rate, the unoccupied car space rate, etc. by accessing the center 1 from the mobile terminal 2 of the client, and can determine whether or not the client is to actually visit the store. Although a client who accesses the center 1 to check the store information, he or she may or may not actually visit the store possibly depending on the unoccupied seat rate. The example shown in FIG. 5 indicates that when the unoccupied seat rate is lower than 10%, the visiting rate of clients is normally low. According to the store information from the center 1, the clients A and B stops actually visiting the Yamashita Park Store to avoid the crowded store when they are informed that the unoccupied seat rates are as low as 5% and 9% respectively. The clients C and D actually visit the store because they are informed that the unoccupied seat rates are as high as 30% and 50% respectively.

In the second example of an application, the mind of a client as shown in FIG. 5 is read according to the data in the client demand information integration device 10, and the relationship between the state of the store such as an unoccupied seat rate, etc. and the probability of the client actually visiting the store is analyzed.

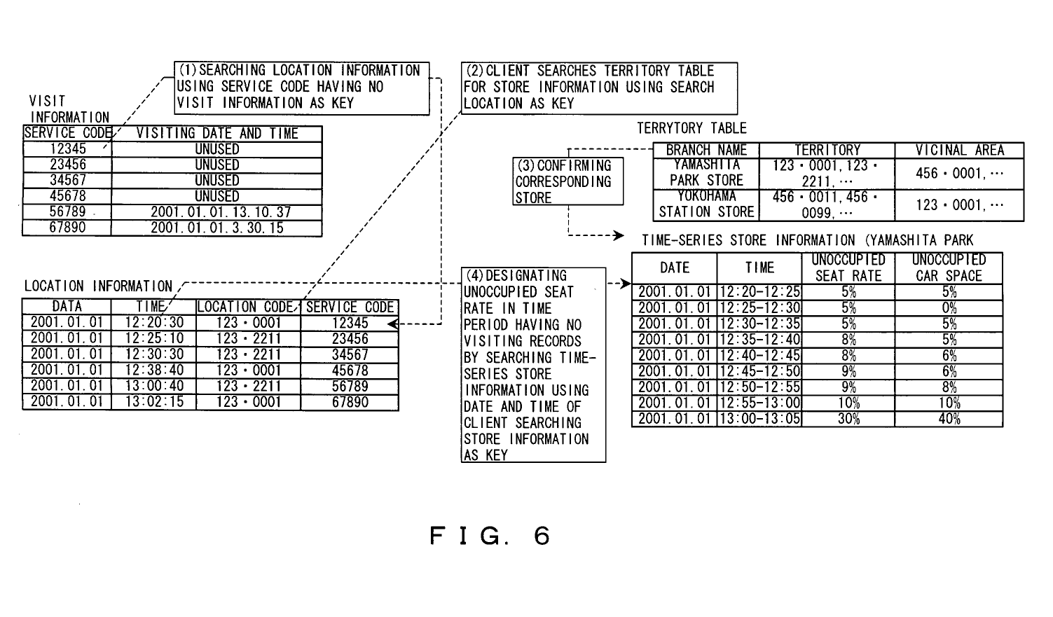

FIG. 6 shows the second example of an application of the information stored in the client demand information integration device 10.

In FIG. 6, the location information database 13 is searched and a corresponding record is read using as a search key the service code stored in a record not storing visiting date and time, that is, having no visiting records stored in the visit information database 14 ((1)). Using the location code stored in the record, the territory information database 16 is searched ((2)) to confirm the corresponding store ((3)). Then, the store, the time, and the unoccupied seat rate corresponding to the access having no visiting records can be designated ((4)) by searching the time-series store information using as a search key the date and time at which the store information is searched by the client accessing the center 1 which is stored in the record read in (1). Thus, information for the access having no visiting record is sequentially retrieved from each database. When the process has been completed on all records having no visiting records, the material for trend analysis is generated from the extracted information.

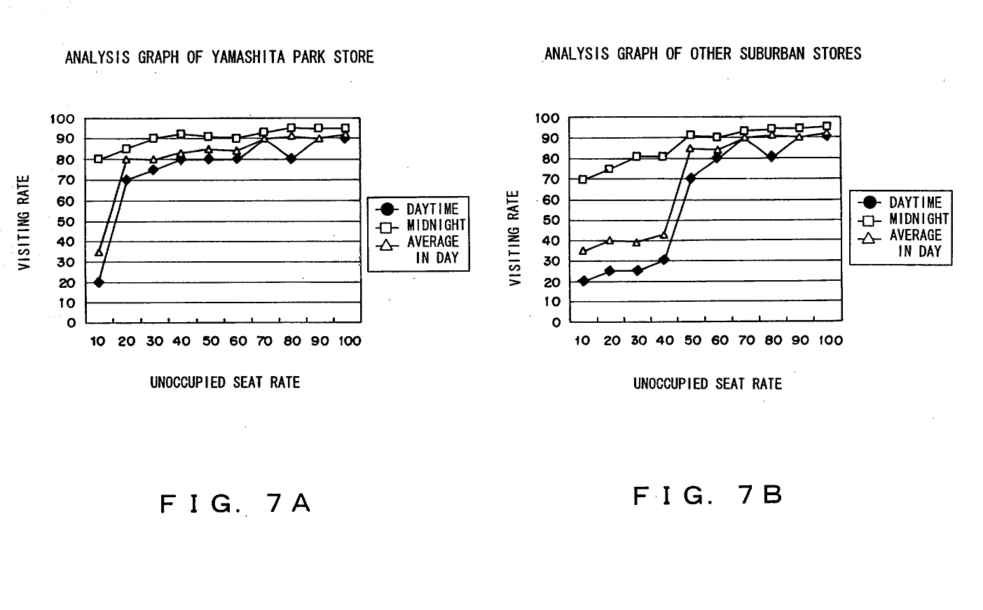

FIG. 7 shows an example of the material for trend analysis generated according to the information extracted from the client demand information integration device 10 in the second example of an application.

FIG. 7A is a graph for each time period showing the relationship between the unoccupied seat rate obtained when the client accesses the center 1 and the visiting rate of the client checking the store information about the Yamashita Park Store. FIG. 7B is a similar graph about the other suburban stores.

In FIG. 7A, it is informed that in any time period in the Yamashita Park Store, the visiting rate sharply lowers when the unoccupied seat rate is lower than 20%. In the midnight time period, an average visiting rate can be obtained at any unoccupied seat rate. However, on average in a day, the visiting rate is quite different between the unoccupied seat rate higher than 20% and the unoccupied seat rate lower than 20%. Therefore, according to the analysis result in the Yamashita Park Store, it is informed that the unoccupied seat rate is to be kept over 20%, or a sufficient service is to be offered in a time period in which the visiting rate is low so as to invite more clients at the unoccupied seat rate lower than 20%.

As shown in FIG. 7B, in the suburban stores other than the Yamashita Park Store, the visiting rate is low although the unoccupied seat rate is as high as about 40%. It can be estimated that the clients who visit the suburban stores are less patient of the crowd than the clients who visit the urban stores such as the Yamashita Park Store. Therefore, in the suburban stores, it is necessary according to the analysis result to prepare a sufficient number of seats not to lower the unoccupied seat rate, or to improve the service in a time period in which the unoccupied seat rate becomes low.

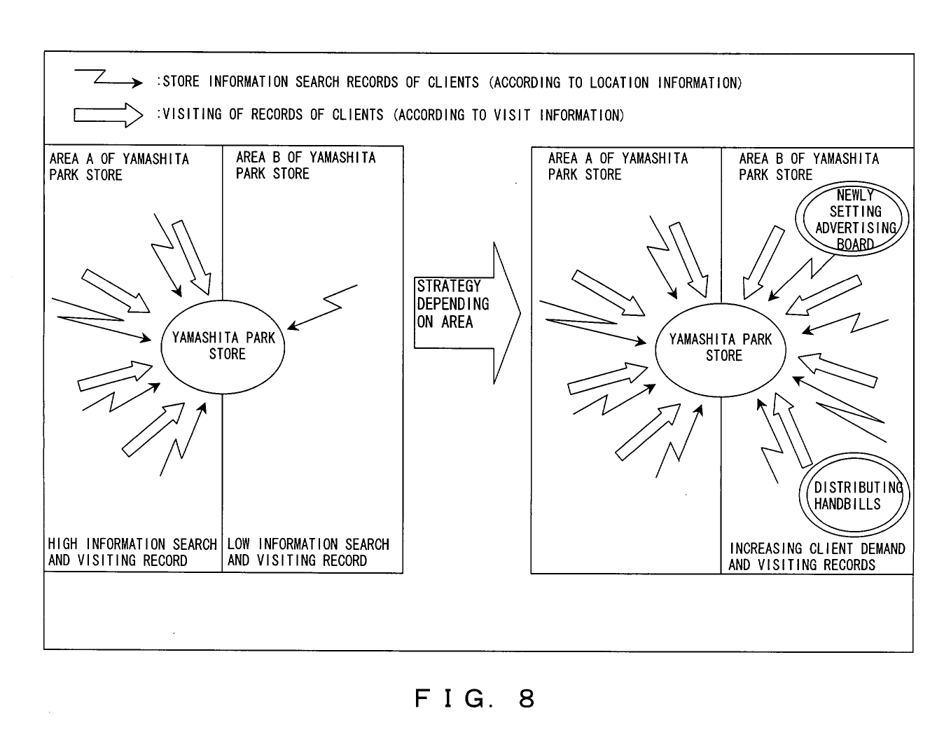

FIG. 8 shows the third example of an application of the information stored in the client demand information integration device 10.

In the third example of the application, it is determined from which area the advantage of access or visiting are higher in the territory of an analysis target store the territory of the store entered in the territory information database 16 is divided into a plurality of areas, and the location information database 13 is searched using as a search key the location code of the area, thereby checking the retrieval result by the client, and the visit information database 14 is searched by the service code in the record retrieved from the location information database 13, thereby checking the visiting records of the client.

FIG. 8 shows the summary of the information retrieval results and the visiting records of the client accessing the center 1. As shown in FIG. 8, in the Yamashita Park Store, the information retrieval results and the visiting records are high in the area A. On the other hand, in the area B, the information retrieval results and the visiting records are low.

Therefore, as a result of the analysis, it is necessary to specifically improve the sales results in the area B by setting an advertising board along the main street in the area B, or distributing handbills, etc.

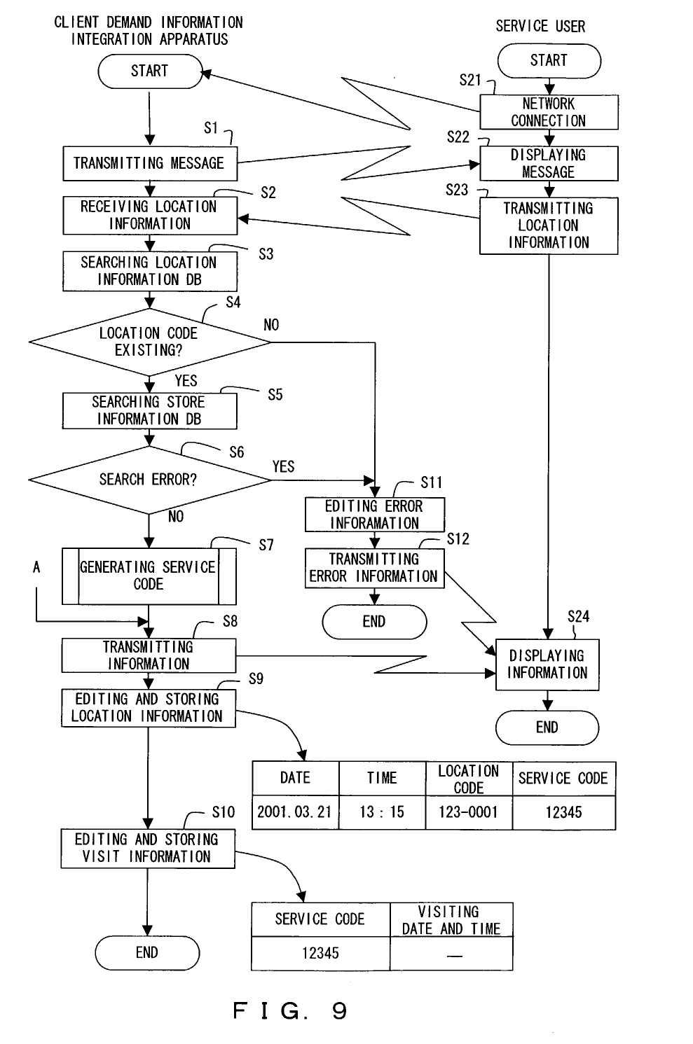

FIG. 9 is a flowchart of the process performed by the location information integration program 11 of the client demand information integration device 10 in response to the access from a client, and the process of the mobile terminal 2.

The client accesses the center 1 by connecting the mobile terminal 2 to the network 4 (step S21) to obtain demand information.

On the other hand, the client demand information integration device 10 activates the location information integration program 11, and transmits a message such as “The nearest store information is displayed. Your location information is requested.” to prompt the mobile terminal 2 accessing in step S1 to transmit the location information.

On the other hand, in step S22, the client manually transmits the location information on the mobile terminal 2, or transmits it automatically by the function of the program operating on the mobile terminal 2 or through transmission permission input by the client.

Upon receipt of the location information from the mobile terminal 2 (step S2), the location information integration program 11 searches the location information database 13 according to the location information in step S3, and retrieves a branch which is a store in the territory or a vicinal store. If the received location information is not recorded in the location information database 13 as a retrieval result (NO in step S4), then the access location of the client goes out of scope of the management of the center 1, thereby passing control to the error process in step S11. In the error process, error information for notification of an error in step S11 is edited, and is transmitted in step S12, thereby terminating the process.

If the received location information is recorded in the location information database 13 in step S4 (YES in step S4), then the location information integration program 11 retrieves the store information about a store in the territory or a vicinal store retrieved by the information terminal 3 from the current store information database 15 in step S5. If a retrieval error occurs for any reason as a result of the retrieval result (NO in step S6), then control is passed to the error process in step S11, and the error information is transmitted to the mobile terminal 2.

If no retrieval error occurs in step S6 (YES in step S6), then the location information integration program 11 performs a service code generation process in step S7, display information is generated from the store information retrieved in step S5 and the service code generated in step S7, and the information is transmitted as notification information to the mobile terminal 2 in step S8. Then, in step S9, the location information integration program 11 stores the information about the date and time at which access is gained to the center 1 from the mobile terminal 2 and the service code generated in step S7 in the location information database 13. Finally, the record in which only the service code generated in step S7 is stored and a visiting date and time is not stored, is generated and stored in the visit information database 14 in step S10, thereby terminating the process.

Upon receipt of an error message or display information from the center 1, the mobile terminal 2 displays them on the screen (step S24), thereby terminating the process. The contents of the display are used in determining the action to actually visit the store, etc.

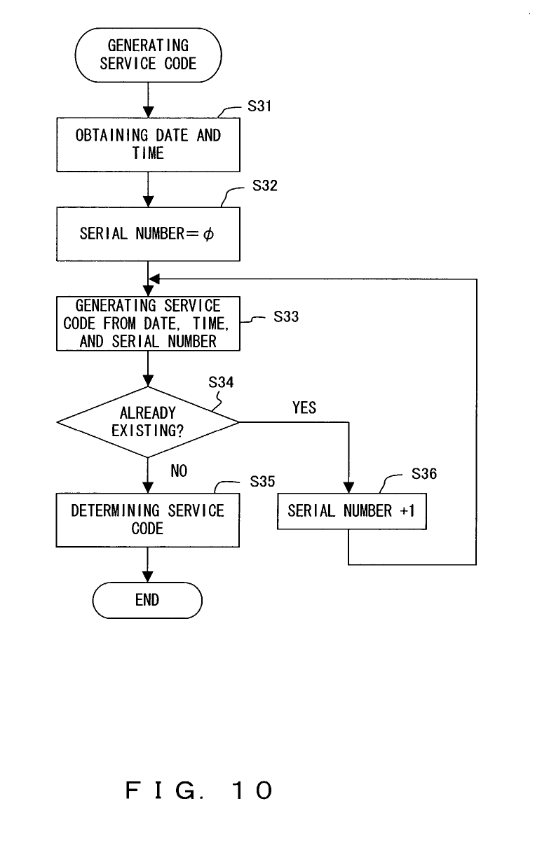

FIG. 10 is a flowchart of an example of a service code generating process in step S7 shown in FIG. 9.

In the explanation below, a service code is generated according to date and time information, but a service code can be generated by sequentially counting up the counter in the order of the generation request of a service code.

In FIG. 10, when a request to generate a service code is issued, the location information integration program 11 first obtains the current date and time information in step S31. Then, in step S32, the serial number is initialized to 0. In step S33, the date and time information obtained in step S31 is combined with the serial number, thereby generating a service code.

In step S34, the location information database 13 or the visit information database 14 is searched to check whether or not the service code generated in step S33 has already existed for any reason, for example, by simultaneously generating service codes plural times. As a result, if the same number already exists as a service code (YES in step S34), then the serial number is incremented by 1 in step S36, control is passed to step S33, and a service code is generated again.

If the same number does not exist as a service code in step S34 (NO in step S34), then the number generated in step S33 is defined as a service code in step S35, thereby terminating the process.

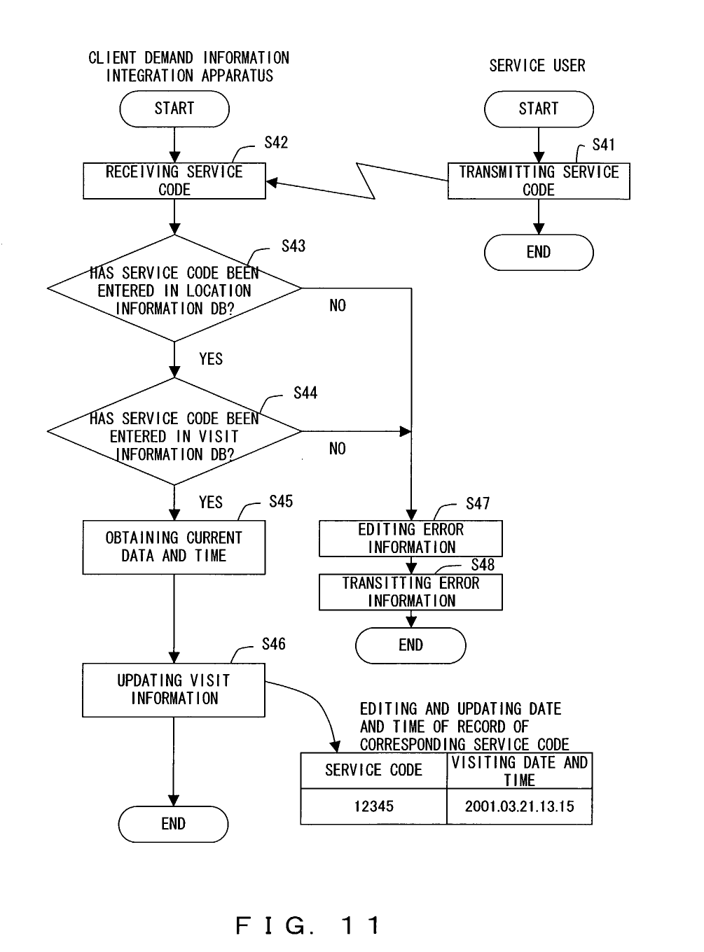

FIG. 11 is a flowchart of the process performed by the visit information integration program 12 of the client demand information integration device 10 when a notification of a service code of a client visiting the store is received from the information terminal 3.

As shown in FIG. 11, if a client visiting the store presents a service code, the staff of the store uses a POS together with the information terminal 3 to transmit the service code to the center 1 (step S41).

Upon receipt of the service code, the center 1 activates the visit information integration program 12 in the client demand information integration device 10 and accepts the service code (step S42). The visit information integration program 12 checks in step S43 whether or not the service code has already been entered in the location information database 13. If the service code has already been entered in the location information database 13 (YES in step S43), then it is checked in step S43 whether or not the service code has already been entered in the visit information database 14. If the service code has not been entered in the location information database 13 or the visit information database 14 as a result of the check in steps S43 and S44 (NO in step S43 or S44), error information for notification of an error to a store is edited (step S47), the edited information is returned to the information terminal 3 of the store which has transmitted the service code in step S48, thereby terminating the process.

If the service code has been entered in the visit information database 14 in step S44, then the current date and time are obtained in step S45, the date and time are recorded in step S46 in the record storing this service code in the visit information database 14 as the entry of the visit of the client of the service code, thereby terminating the process.

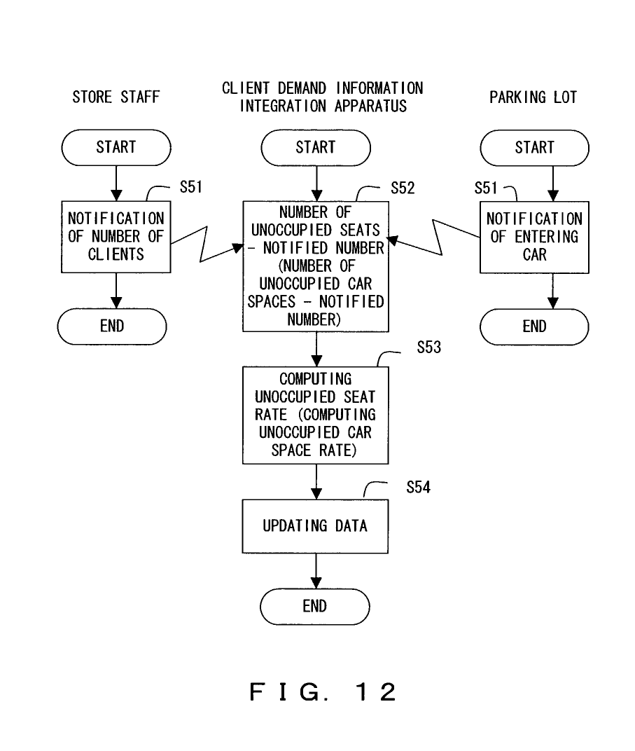

FIG. 12 is a flowchart of the process of updating the store information when a client enters a store or a car enters a parking lot in the store managed by the center 1.

When a client enters a store or a car enters a parking lot, the information terminal 3 notifies the center 1 of the number of the visiting clients and the number of cars entering the parking lot (step S51).

In the center 1, the client demand information integration device 10 receives the notifications, and subtracts the notified number of clients (the number of cars for the parking lot) from the current number of unoccupied seats (the current number of available car spaces for the parking lot) stored in the current store information about the store in the current store information database 15 in step S52, thereby updating the current number of unoccupied seats (the current number of available car spaces for the parking lot). In step S53, the unoccupied seat rate (unoccupied car space rate) is obtained from the value obtained in step S52 and the total number of seats (the total car spaces in the parking lot). In step S54, the updated data is reflected on the current store information in the current store information database 15, thereby terminating the process.

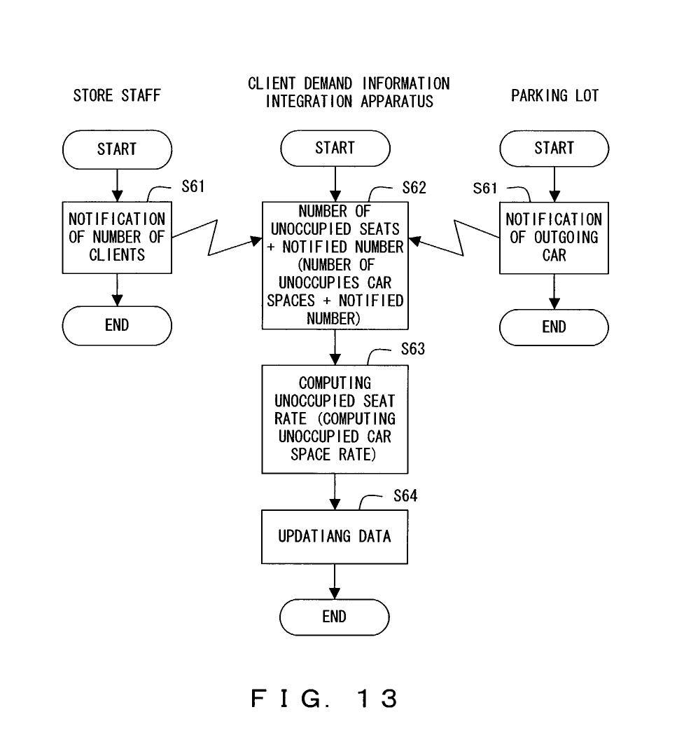

FIG. 13 is a flowchart of the process of updating the store information when a client exits the store managed by the center 1.

If a client exist the store or a car exist the parking lot, then the information terminal 3 operated with the POS, etc. of the store notifies the center 1 of the number of outgoing cars and the number of outgoing clients (step S61).

In the center 1, the client demand information integration device 10 receives the notifications, and adds the notified number of clients (the number of cars for the parking lot) to the current number of unoccupied seats (the current number of available car spaces for the parking lot) stored in the current store information about the store in the current store information database 15 in step S62, thereby updating the current number of unoccupied seats (the current number of available car spaces for the parking lot). In step S63, the unoccupied seat rate (unoccupied car space rate) is obtained from the value obtained in step S62 and the total number of seats (the total car spaces in the parking lot). In step S64, the updated data is reflected on the current store information in the current store information database 15, thereby terminating the process.

Described below as the second embodiment of the present invention is the process of notifying the client, in response to the access from a client, of map information in addition to the information about the situation of the nearest store.

In the above mentioned embodiment, when a client accesses the center 1 from the mobile terminal 2, the center 1 notifies as a reply the client of the store information such as the unoccupied seat rate, the unoccupied car space rate, etc. as store information. In the second embodiment, the center 1 notifies the client of map information about the location of the nearest store as notification information in addition to the above mentioned store information. Thus, the client can easily visit a store which is normally difficult to be located. Furthermore, the map information can include guide information containing the information about an eye-catching mark for easy approach to the store and trend information about a construction sit, a traffic jam point, etc. Additionally, the guide information can be given to the client accessing from a low visiting rate area so that the visiting rate can be improved relating to specific clients who are to receive high quality services.

Furthermore, the system configuration according to the second embodiment is basically the same as the configuration shown in FIG. 1 except that the client demand information integration device 10 has additional functions of obtaining the map information through the network 4, holding the information as a database, etc., and the information terminal 3 of each store has the function of allowing an operator such as a staff of the store, etc. to input additional information.

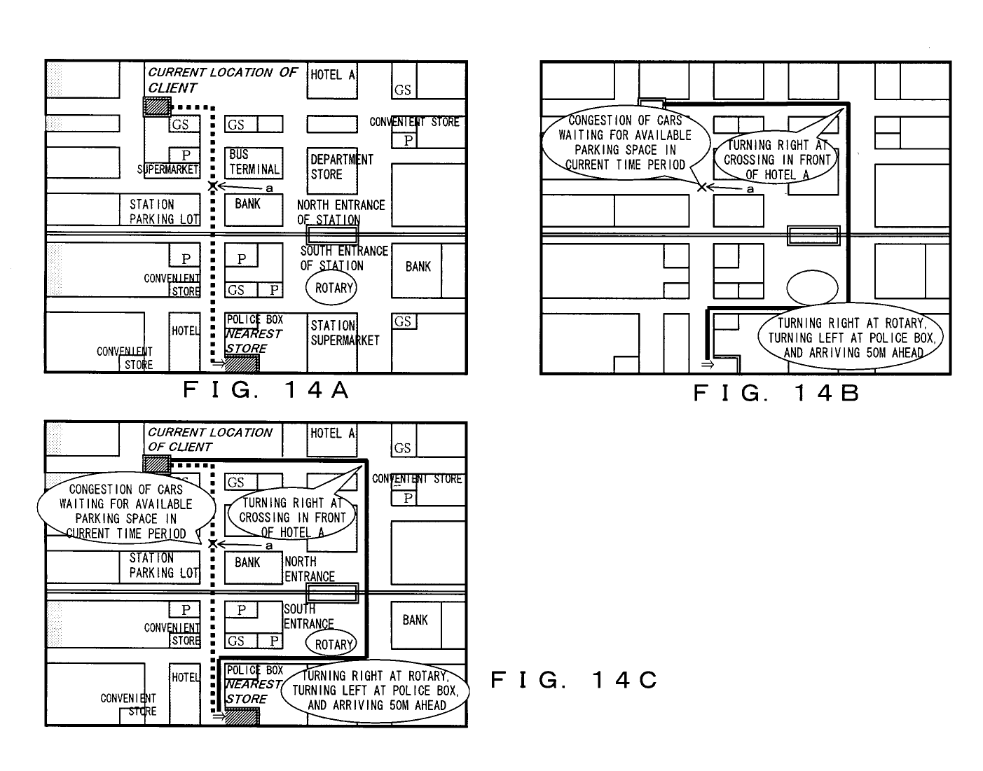

FIG. 14 shows an example of the map information for use in the second embodiment.

FIG. 14A shows general-purpose road map data including the current location of the client and the nearest store of which the client is to be informed. The map data is obtained by the client demand information integration device 10 requesting through the network 4 for necessary information such as a location, scale, etc. and obtaining the information from a map information providing site external to the center 1. The map data can be obtained from the database device in the center 1, or obtained from a database provided in the client demand information integration device 10. When the mobile terminal 2 has GPS navigation capabilities, the map data can include client location information and route information (indicated by the dotted lines in FIG. 14A) to the nearest store which are operated with the GPS navigation capabilities of the mobile terminal 2.

When the guide information is added to the map data, the client demand information integration device 10 transmits the original map data as shown in FIG. 14A to the information terminal 3 of the store which is notified to the client as the nearest store.

The map as shown in FIG. 14A is displayed based on the map data on the screen of the information terminal 3 of the store which has received the map data. The operator such as a staff of a store, etc. of the information terminal 3 adds guide information with the trend around the store as shown in FIG. 14B on the display screen.

In the example shown in FIG. 14, the shortest route for the client to the store is indicated by the dotted line shown in FIG. 14A, and the car navigation, etc. guides the route. However, congestion actually occurs at the point “a” shown in FIG. 14A, and it takes time to reach the store due to the congestion if the route indicated by the dotted line is taken. Then, a map as shown in FIG. 14C is generated with the guide information as shown in FIG. 14B added to the map information using the original map data as shown in FIG. 14A. The map is transmitted to the mobile terminal 2 of the client through the client demand information integration device 10 together with the store information such as an unoccupied seat rate.

To the guide information, information about the route through which the store can be reached than the suggested short route indicated by the dotted line as shown in FIG. 14C, and information which is the guide to the route such as an eye-catching mark, etc. to follow the route, which is the information with the latest state input by a staff, etc. of the store, can be added. The information changes with the passage of days, time, etc. By inputting the guide information by the staffs of the store, the guide information corresponding to the change can be provided for the client.

Thus, a high quality service can be provided for clients such that a visiting rate can be improved.

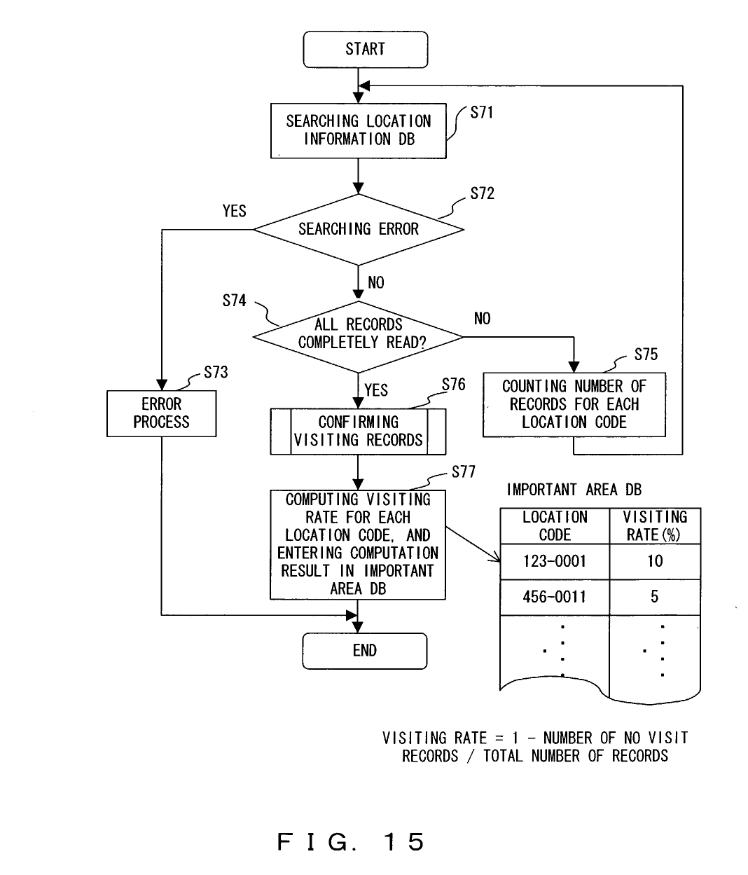

FIG. 15 is a flowchart of the process of entering the important area database according to the second embodiment of the present invention.

The important area database is used for storage and management of an area for which a large amount of access is gained from clients but which indicates a low visiting rate. In the second embodiment, when access is received from a client in an area entered in the important area database, guide information is added to map information for notification to the client.

The important area database can be automatically obtained for an area having a low visiting rate for an analysis, and can be obtained for easy procurement of the map in the area and the store in the territory.

The important area database is provided in the client demand information integration device 10, and is updated by performing the process shown in FIG. 15 is performed for each weekend using the data in the location information database 13 and the visit information database 14.

In step S71 shown in FIG. 15, the location information database 13 is searched for a corresponding record. In searching the location information database 13, a record satisfying a specified condition depending on an object for which a service of guide information is provided, for example, a record in a specific period is read using a date as a search key, a record in a specific area period is read using a time as a search key, and a record in a specific time period is read using a time as a search key.

When a search error occurs in the searching process in step S71 (YES in step S72), an error process by, for example, transmitting the contents of an error in step S73, thereby terminating the process. If no search error occurs (NO in step S72), then the process of reading a record is performed based on the condition until reading all records in the location information database 13 is completed (NO in step S73), and the number of records is counted for each location code for the record read in step S75.

If all records satisfying the condition have been read and the count of each location code has been completed (YES in step S74), then the visit record confirming process is performed in step S76.

In step S77, the visiting rate of a client accessing from the area represented by a location code is computed for each location code in step S77. The result is entered in the important area database corresponding to the location code, and the process terminates. The visiting rate is obtained, for example, by dividing the number of no visit records obtained in the visit record confirming process in step S76 for the location code in the location information database 13 by the number of all records of the location code counted in step S75, and then subtracting the result from “1”.

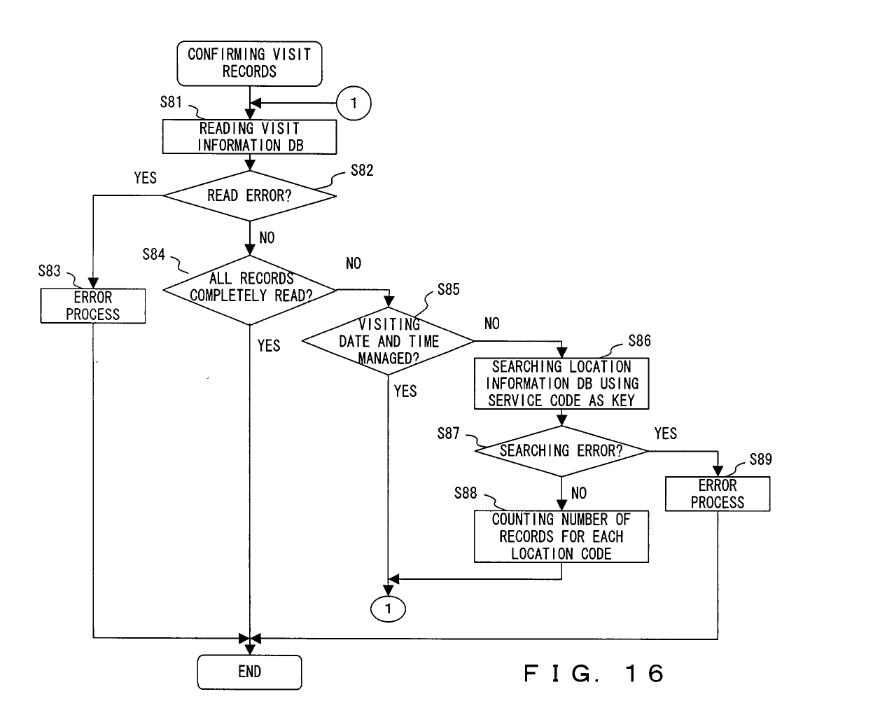

FIG. 16 is a flowchart of the detailed process in the visit record confirming process in step S76 shown in FIG. 15.

When the visit record confirming process is entered, a record in the visit information database 14 is read in step S81.

When a read error occurs at this time (YES in step S82), then an error process such as transmitting the contents of the error in step S83 is performed, there by terminating the process. If no error occurs (NO in step S82), and the read of all records has not been completed (NO in step S84), then it is determined in step S85 whether of not the read records contain visiting dates and times. The records having no visiting dates and times indicate that there were no visits relating to the service codes. The records having visiting dates and times entered and managed indicate that there were visits relating to the service codes. Therefore, if read records contain managed visiting dates and times (YES in step S85), then there were visits, no counting is made, control is returned to step S81, and the next record is read.

If a record stores no visiting date and time in step S85 (NO in step S85), then the location information database 13 is retrieved using the service code in the record read in step S71 as a search key. If an error occurs as a retrieval result (YES in step S87), then the process terminates after performing an error process in step S89. If no error occurs (NO in step S87), then the number of records is counted in step S88 for each location code in the records retrieved in step S86. For example, if 123-0001 is recorded as a location code in the record retrieved in step S86, then the count value of 123-0001 is incremented.

After the record number counting process in step S88 is performed, control is returned to step S81, and the next record is read from the visit information database 14. If all records in the visit information database 14 have been completely read (NO, in step S83), then the process terminates.

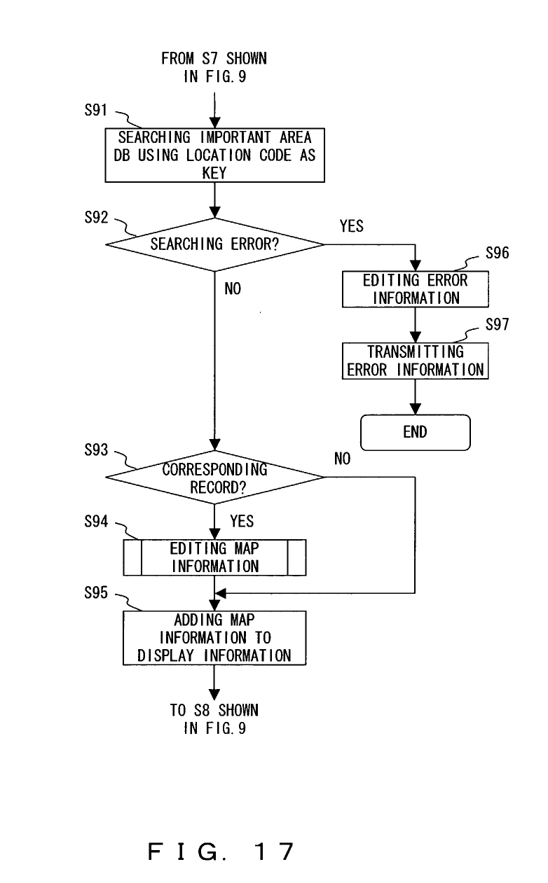

FIG. 17 is a flowchart of the process performed by the location information integration program 11 of the client demand information integration device 10 in response to the access from the client according to the second embodiment of the present invention.

In the process performed in response to the access from the client according to the second embodiment, the process in FIG. 17 is added to the portion A (between steps S7 and S8) of the process in the flowchart shown in FIG. 9. In the following explanation, the process also shown in FIG. 9 is omitted.

In FIG. 17, when the service code generating process in step S7 is completed, an important area database is searched using the location code of an area from which a client accesses as a key. If a search error occurs as a result (YES in step S92), error information is edited in step S96, and the information is transmitted in step S97, thereby terminating the process.

If there is no search error in step S92 (NO in step S92), and a record corresponding to the location code exists in the important area database as a search result (YES in step S93), the map information editing process in step S94 is performed because the access location of the client has a low visiting rate. And if no corresponding record exists in the important area database (NO in step S93), the map information editing process in step S94 is not performed, because it is not necessary to add guide information to this location having a high visiting rate. Then the notification information is generated in step S95 by adding the map information to the store information retrieved in step S5 and the display information generated from the service code generated in step S7. Then, the notification information is transmitted to the mobile terminal 2 in step S8 shown in FIG. 9.

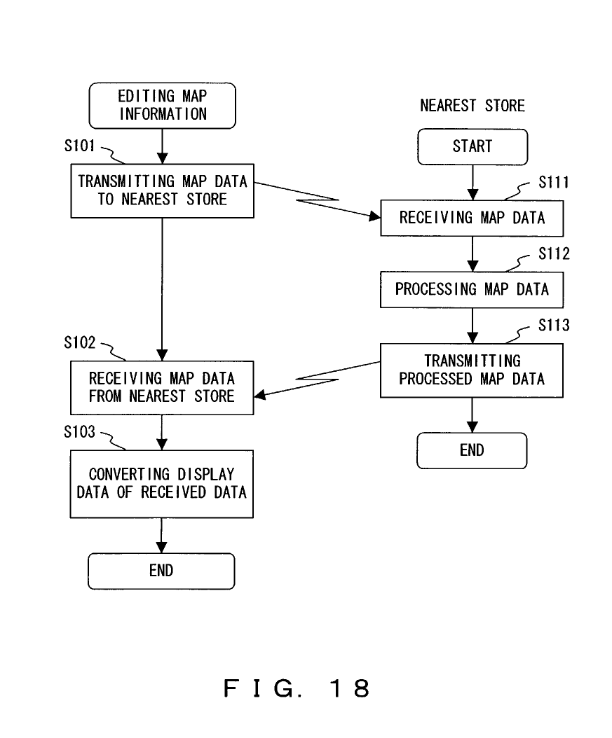

FIG. 18 is a flowchart of the details of the map information editing process in step S94 shown in FIG. 17.

The map information editing process is performed when guide information is added to map information and transmitted to the client.

When the map information editing process starts, the client demand information integration device 10 transmits the map data on which the map information is generated to the information terminal 3 of the nearest store in step S101.

Upon receipt of the map data in step S111, the information terminal 3 adds the guide information as shown in FIG. 14B to the map data in step S112 by overwriting the displayed map information by an operator of the information terminal 3 such as a staff of the store using an input tool such as a pointing device, a touch pen, etc., thereby processing the map data. Then the processed map data is returned to the client demand information integration device 10 in step S113.

Upon receipt of the map data from the information terminal 3 of the nearest store (step S102), the location information integration program 11 of the client demand information integration device 10 converts the received data into the display data displayable by the mobile terminal 2, thereby terminating the process.

In the flowchart shown in FIG. 18, each time there arises access from a client in an area having a low visiting rate, guide information is input by an operator of the information terminal 3. However, guide information is prepared in the information terminal 3 in advance, and the information can be combined with the map data transmitted from the client demand information integration device 10. At this time, at each specific date and time, or when any contents are to be changed, the operator of the information terminal 3 updates the guide information.

If the guide information is generated in advance, then the generated guide information is not stored in the information terminal 3 of each store, but is stored as a database in the client demand information integration device 10, the guide information corresponding to the access from the client is retrieved from the database and combined with the map data, and can be transmitted to the client. At this time, an operator such as a staff of a store, etc. updates the guide information from the information terminal 3 through the network 4.

In the processes shown in FIGS. 17 and 18, the map information to a store in addition to the store information of the nearest store can be provided for a client in response to the access of the client. In response to the access from an area having a low visiting rate, the guide information with trend data together with the map information can be provided for a client.

In the above mentioned second embodiment, only the map information is transmitted with the guide information added to the map information in response to the access from an area having a low visiting rate, but the second embodiment is not limited to the above mentioned transmission, but the guide information can be transmitted in response to the access from all areas, or it can be designed such that the area in which the map information is not transmitted is provided corresponding to the visiting rate.

In the explanation above, as a specific condition, a larger amount of information can be provided for a client depending on the visiting rate of an access area of a client. However, the specific condition is not limited to a visiting rate of an access area of a client. For example, a larger amount of information can be provided for a client when the nearest store has a low visiting rate.

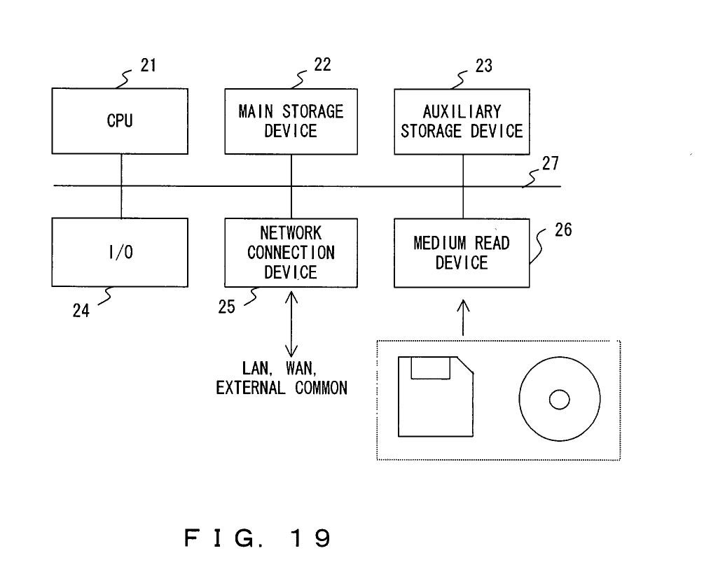

FIG. 19 shows the information processing system environment of the center 1, and the information terminal 3 according to the present embodiment.

The information processing system comprises, as shown in FIG. 19, a CPU 21, a main storage device 22 which is a work area of each program, an auxiliary storage device 23 such as a hard disk, etc. storing each program and database, an input/output device (I/O) 24 such as a display, a keyboard, etc., a network connection device 25 such as a modem, etc., a medium read device 26 for reading stored contents from a portable storage medium such as a magnetic tape, etc. They are interconnected through a bus 28.

In the information processing system shown in FIG. 19, a program and data stored in a storage medium 27 such as a magnetic tape, a flexible disk, CD-ROM, an MO, etc. are read by the medium read device 26, and are downloaded into the main storage device 22 or the auxiliary storage device 23. Each process according to the present embodiment can be realized as software by the CPU 21 executing the program and data.

In the information processing system shown in FIG. 19, application software can be exchanged using the storage medium 27 such as a flexible disk, etc. Therefore, the present embodiment is not limited to the demand information integration system and method, but can be configured as the computer-readable storage medium 27 used to direct a computer to perform the functions of the embodiments of the present invention.

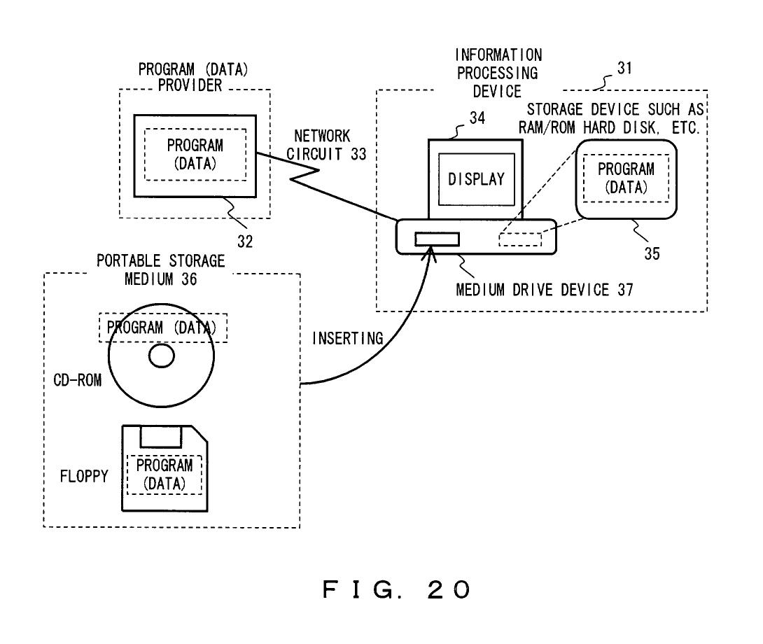

In this case, the ‘storage medium’ includes, as shown in FIG. 20, a portable storage medium 36 removable from a medium drive device 37 such as CD-ROM, a flexible disk (or an MO, DVD, removable hard disk, etc.), a storage device (database, etc.) 32 in an external device (server, etc.) transmitted through a network circuit 33, or memory (RAM or a hard disk, etc.) 35, etc. in a body 34 of an information processing device 31. A program stored in the portable storage medium 36 and the storage device (database, etc.) 32 is loaded into the memory (RAM or a hard disk, etc.) 35 for execution.

According to the present invention, a service provider can collect information from a service user who has not actually visited a store.

In addition, according to the present invention, since the location information about the access location of a service user, and the information as to whether or not a client has actually visited the store, which has not been obtained before, can be obtained, client demand information can be extended, and can be more widely applied in various fields.

Furthermore, since a service user can refer to store information in real time about the nearest store in advance, the conditions of a plurality of stores can be compared and a store which the service user can actually visit can be selected, and the service user will not complain that he or she cannot enter the store because it has already been full. Furthermore, using the system according to the present invention, a service user can be gave a service such as a discount, etc. As a result, the service user can be fully satisfied with the service.

Furthermore, by transmitting the map information about the location of a store, the visiting rate of the store can be improved.

In addition, by transmitting the guide information about a store when a specific condition is satisfied such as access from an area having a low visiting rate, the nearest store as a store having a low visiting rate, etc., a high quality service can be provided to improve a visiting rate.

Additionally, since the guide information can be input by a corresponding store, the guide information including a change with time can be provided for a service user.

What is claimed is:

1. A demand information integrating method, comprising:
generating identification information for identification of information about a service user;
receiving the identification information from the service user; and
storing the identification information as associated with store information upon receipt of the identification information.

2. The method according to claim 1, wherein
the information about the service user includes at least one of location information and time information.

3. The method according to claim 1, wherein
the store information includes at least one of unoccupied seat information and parking lot information.

4. A demand information integrating method, comprising:
receiving service user information about a service user;
generating identification information for identification of the service user information; and
returning notification information including the identification information to the service user.

5. The method according to claim 4, wherein
the notification information includes at least one of store information about a condition of a store and parking lot information about an unoccupied car space rate in a parking lot.

6. The method according to claim 4, wherein
the notification information includes map information about a location of a store.

7. The method according to claim 4, wherein
the map information includes guide information generated by the store.

8. The method according to claim 4, wherein
the service user information includes location information about a location of the service user, and when the location information indicates a specific area, the notification information includes guide information generated by the store.

9. The method according to claim 8, wherein
the specific area has a low visiting rate.

10. The method according to claim 4, wherein
the identification information is stored as associated with at least one of the service user information, the store information, and the parking lot information.

11. A method for integrating demand information for analysis of a demand of a service user, comprising:
generating a service code which is a unique identifier in response to access from a terminal device of the service user;
transmitting stored store information about one or more stores to the terminal device of the service user together with the service code; and
storing date-and-time information about a date and time at which the service user gains access as associated with the service code.

12. The method according to claim 11, wherein
upon receipt of the service code from the terminal device of the store through a network, the service code is stored together with information that the service user visits the store.

13. The method according to claim 12, wherein
the information that the service user visits the store indicates a date and time of the service user visiting the store.

14. The method according to claim 11, wherein
the stored store information is updated according to the store information received from the terminal device of the store through a network.

15. The method according to claim 11, wherein
in response to the access from the terminal device of the service user, a request to transmit location information about a location of the service user is issued, and upon receipt of the location information from the service user, the location information is stored as associated with the date-and-time information and the service code.

16. The method according to claim 15, wherein
the store information to be transmitted to the terminal device of the service user is determined according to the location information from the service user.

17. The method according to claim 16, wherein
information for definition of a territory of the store is stored, and the store information about the store whose the territory corresponds to the location information from the service user is transmitted to the terminal device of the service user.

18. The method according to claim 11, wherein
the store information includes information about an unoccupied seat rate of a store.

19. The method according to claim 11, wherein
the store information includes information about an unoccupied car space rate in a parking lot.

20. The method according to claim 11, wherein
the store information and the service code are transmitted to the terminal device of the service user together with map information about a location of a store.

21. A demand information integration apparatus, comprising:
a unit generating identification information for identification of information about a service user;
a unit receiving the identification information from the service user; and
a unit storing the identification information as associated with store information upon receipt of the identification information.

22. The demand information integration apparatus according to claim 21, wherein
the information about the service user includes at least one of location information and time information.

23. The demand information integration apparatus according to claim 21, wherein
the store information includes at least one of unoccupied car space information and parking lot information.

24. A demand information integration apparatus, comprising:
a unit receiving service user information about a service user from a terminal of the service user;
an identification information generation unit generating identification information for identification of the service user information; and
a notification unit returning notification information including the identification information to the terminal of the service user.

25. A server device for use in a system which integrates information for analysis of a demand of a service user, comprising:
a current store information storage unit storing store information about a situation of one or more stores managed by said server device;
a service code generation unit generating a service code which is a unique identifier in response to access from a terminal device of the service user, and transmitting the service code together with the store information stored in said current store information storage unit to the terminal device of the service user; and
a location information storage unit storing date-and-time information about a date and time at which the service user gains access as associated with the service code.

26. A client device for use by a service user of a system which integrates information for analysis of a demand of the service user, comprising:
a transmission unit notifying a server device of location information about a location; and
a reception unit receiving a service code which is a unique identifier together with store information from the server device.

27. A demand information integration apparatus, comprising:
means for generating identification information for identification of information about a service user;
means for receiving the identification information from the service user; and
means for storing the identification information as associated with store information upon receipt of the identification information.

28. A server device for use in a system which integrates information for analysis of a demand of a service user, comprising:
current store information storage means for storing store information about a situation of one or more stores managed by said server device;
service code generation means for generating a service code which is a unique identifier in response to access from a terminal device of the service user, and transmitting the service code together with the store information stored in said current store information storage meams to the terminal device of the service user; and
location information storage means for storing date-and-time information about a date and time at which the service user gains access as associated with the service code.

29. A client device for use by a service user of a system which integrates information for analysis of a demand of the service user, comprising:
transmission means for notifying a server device of location information about a location; and
reception means for receiving a service code which is a unique identifier together with store information from the server device.

30. A computer-readable storage medium storing a program used to direct a computer to perform:
generating identification information for identification of information about a service user;
receiving the identification information from the service user; and
storing the identification information as associated with store information upon receipt of the identification information.

31. The storage medium according to claim 30, wherein
the information about the service user includes at least one of location information and time information.

32. The storage medium according to claim 30, wherein
the store information includes at least one of unoccupied car space information and parking lot information.

33. A computer-readable storage medium storing a program used to direct a computer to perform:
a step of receiving service user information about a service user;
a step of generating identification information for identification of the service user information; and
a step of returning notification information including the identification information to the service user.

34. A computer-readable storage medium storing a program used to direct a computer integrating information for analysis of a demand of a service user to perform:
generating a service code which is a unique identifier in response to access from a terminal device of the service user;
transmitting stored store information about one or more stores to the terminal device of the service user together with the service code; and
storing date-and-time information about a date and time at which the service user gains access as associated with the service code.

35. A computer data signal embodied in a carrier wave and representing control software, said control software comprising the operation of:
generating identification information for identification of information about a service user;
receiving the identification information from the service user; and
storing the identification information as associated with store information upon receipt of the identification information.

36. A computer data signal embodied in a carrier wave and representing control software, said control software comprising the operation of:
receiving service user information about a service user;
generating identification information for identification of the service user information; and
returning notification information including the identification information to the service user.

37. A computer data signal embodied in a carrier wave and representing control software, said control software comprising the operation of:
generating a service code which is a unique identifier in response to access from a terminal device of the service user;
transmitting stored store information about one or more stores to the terminal device of the service user together with the service code; and
storing date-and-time information about a date and time at which the service user gains access as associated with the service code.
